(19) United States
(12) Patent Application Publication
(10) Pub. No.: US 2020/0122754 A1
(43) Pub. Date: Apr. 23, 2020

(54) SYSTEM AND METHOD FOR DETERMINING CHARACTERISTICS OF AT LEAST ONE WHEEL OF A RAIL VEHICLE

(71) Applicant: AUE KASSEL GMBH, Kassel (DE)

(72) Inventor: Christian NOWACZYK, Kaufungen (DE)

(21) Appl. No.: 16/320,301

(22) PCT Filed: Jun. 30, 2017
(86) PCT No.: PCT/EP2017/066324

§ 371 Date: Jan. 24, 2019

(30) Foreign Application Priority Data
Jul. 27, 2016 (DE) 10 2016 113 888.6

(51) Int. Cl. B61K 9/12; B61L 27/00; G01B 11/25

(52) U.S. Cl. CPC B61K 9/12; G01B 11/2513; B61L 27/0094

(57) ABSTRACT

A system and a method for establishing properties of at least one wheel of a rail vehicle, the system including at least one first system part, where the first system part is arrangeable on at least one rail of a track, where the first system part includes at least one first measurement unit, where the first measurement unit includes at least one first electromagnetic radiation source and at least one first detection device, where the first radiation source is formed and configured in such a way that a first pattern is projectable in at least one first region onto the wheel, arranged on the rail, of a rail vehicle by means of the first radiation source, where the first detection device is formed and configured in such a way that the first pattern in the first region on the wheel is detectable by means of the first detection device and where the first pattern is an at least two-dimensional pattern.

### TECHNICAL FIELD

A system and a method for establishing properties of a wheel and/or of a wheelset of a rail vehicle, in particular of a geometric actual state of the wheel and/or wheelset.

### BACKGROUND

The wheels of a rail vehicle are subject to wear or damage and abrasion as a result of the loads during operational use. In the process, the wear behavior of a wheel of a rail vehicle is influenced, for example, by the mileage, in particular depending on the route characteristic, the normal force per wheel and the driving and braking forces. In addition to continuous loads which lead to plastic deformation in the region of the tread, for example, individual events such as strong braking are also responsible for the wear. While the tread, in particular, is loaded in the case of trains, the wheel flange, in particular, is affected by wear in the case of streetcars, for example, on account of the tight curve radii during driving operation.

The abrasion or deformation of the wheels of a rail vehicle is acceptable within predetermined limits and must therefore be controlled at regular intervals. Planning the maintenance of wheels and wheelsets of rail vehicles therefore has as a prerequisite knowledge of the actual wear behavior that is as accurate as possible in order to avoid unnecessary servicing or repairs but, at the same time, to identify damage and wear in timely fashion. To this end, each individual wheel is subject to regular checks, the intervals of which are often set on the basis of the mileage without, however, taking account of the actual loads.

In order to reduce the outlay for a regular detection of the current properties of a wheel, automatic systems that, e.g., optically detect the surface of a wheel have proven to be advantageous in practice. In this respect, the prior art has disclosed a multiplicity of different systems with varying precision.

By way of example, DE 10 2012 207 427 A1 discloses a method for checking a tread of a wheel of a train by optical scanning means. For detection purposes, the one camera is arranged in such a way that the tread of the wheel rolling along a rail is optically detected over the entire circumference thereof by adapting the depth of field of the camera and said tread is subsequently analyzed.

EP 1 992 167 B1 discloses a method for measuring properties of wheels of a rail vehicle, in which a reference marking is arranged in the track, said reference marking being identified in addition to the wheel to be detected by an image detection apparatus of the system.

However, the systems and methods known from the prior art are disadvantageous in that the detection of the surface of a wheel of a rail vehicle is not implemented with sufficient accuracy.

### BRIEF SUMMARY

The disclosure is directed toward a system and a method for establishing properties of a wheel and/or of a wheelset of a rail vehicle, in which the accuracy of the established properties of the wheel and/or of the wheelset is increased in comparison with systems and/or methods known from the prior art.

In a generic system for establishing properties of a wheel of a rail vehicle, the aforementioned is achieved by virtue of the first measurement unit comprising at least one further detection device, specifically a second detection device, and by virtue of the second detection device being formed and configured in such a way that the first pattern in the first region on the wheel tire is detected using the second detection device. The second detection device is configured to detect the first pattern in the first region on the wheel tire.

The system comprises at least one first system part, which is arranged on at least one rail of a track. The track comprises two rails extending substantially in parallel, wherein a passing rail vehicle is guided by the two wheels of a wheelset, with each on one of the rails. By way of example, the first system part is fastened to an assembly plate, which passes under the rail and is screwed to the rail base using two tensioning plates. A tensioning plate is arranged on each side of the rail, said tensioning plate interacting within the assembly plate with threads, in particular.

The first system part comprises at least one first measurement unit, wherein the first measurement unit comprises at least one first electromagnetic radiation source and at least one first detection device. The first radiation source is formed and configured, specifically arranged on the rail of the track, in such a way that a first pattern is projectable in at least one first region onto a wheel, of a rail vehicle, standing on the rail or passing along the rail—i.e., a wheel arranged on the rail—by means of the first radiation source. The first radiation source is configured to project a first pattern in the first region on the first wheel. Here, whether the wheel is at rest or moved is of no importance to the functionality of the system; the system works in both cases. In particular, the system is embodied to detect the properties of a passing wheel within a speed range between 0.5 km/h and 100 km/h, in particular between 5 km/h and 15 km/h.

As a result of the first radiation source being arranged at a fixed position relative to the rail, the projection direction of the first radiation source is known, and so the first radiation source can be aligned in such a way that a first pattern is projectable in at least one first region onto a first wheel, of a rail vehicle, standing on or passing along—arranged on—the rail.

The electromagnetic radiation sources of the system, in particular the first radiation source, are embodied as a laser, for example. Preferably, the radiation source comprises at least one lens for expanding the laser beam in addition to a laser diode for the laser. The radiation source is formed in such a way that a pattern is projectable using the radiation source. In particular, the laser is a laser in the region of light visible to humans, i.e., in the region of a wavelength between approximately 380 nm and 780 nm. This corresponds to frequencies from approximately 789 THz to 384 THz. The laser beam is expanded in order to obtain a planar, two-dimensional projection, for example in the first region. As an alternative or in addition thereto, a lens with a pattern and/or a separate pattern stop is further provided for the radiation source. The lens with a pattern or the pattern stop serves to produce the pattern to be projected, in particular the first pattern, on the wheel.

The pattern is an at least two-dimensional, planar pattern; i.e., for example, a mesh, a point cloud, intersecting circles or intersecting other geometric forms, and any pattern suitable for projection onto a wheel.

The pattern is projected onto a set first region on the wheel by the first radiation source, at least at the time at which the wheel, of a rail vehicle, arranged—standing—on the rail or passing along the rail is at a certain, defined position. Here, the first radiation source is arranged at a predetermined angle—obliquely—in relation to the wheel such that the planar, two-dimensional pattern is distorted on the three-dimensional surface of the wheel.

The—distorted—pattern imaged in the first region on the wheel is detected by the first detection device and supplied to an evaluation unit with a database. The form of the surface of the wheel can be calculated from the distortion of the pattern imaged in the first region in relation to the known—projected—intended form of the pattern. Since the positioning angles of the detection device relative to the rail and/or the wheel and/or the first region are known, the surface can be determined, for example, by means of a triangulation with a plurality of points.

To this end, the first detection device is formed and configured in such a way that the first pattern in the first region on the wheel is detectable using the first detection device. The first detection device is formed to detect the first pattern in the first region on the first wheel. To this end, the detection device is formed in such a way that it converts the electromagnetic radiation reflected by the wheel in the frequency range of the radiation source into an image data record that is further processable or evaluable in digital fashion. The first measurement unit further comprises at least a second detection device, which is formed and configured, specifically fastened to the rail, in such a way that the first pattern in the first region on the wheel standing on, or passing along, the rail is detectable using the second detection device. Consequently, the second detection device is arranged on the rail of the track, for example fastened to the assembly plate, in such a way that the second detection device can likewise detect the first region on the wheel in order to produce a further—second—image data record of the first region.

The first detection device and the second detection device are arranged on the rail in such a way that they detect the first region on the passing wheel, and hence also the pattern projected in the first region, from different angles, in particular at the same time—the trigger time. Since the arrangement of the first detection device and the second detection device relative to the rail is known, these geometric data can be supplied to the evaluation unit and taken into account when evaluating the image data.

Preferably, the system comprises an evaluation unit, which is embodied as a computer system, for example. The evaluation unit is connected to the measurement unit by means of optical waveguides, for example. In particular, the evaluation unit comprises a database in which the detected data are storable and from which they are recallable. The evaluation unit is configured in such a way that it evaluates the first image data record of the first detection device of the first region and the second image data record of the second detection device of the first region in stereoscopic fashion. The first image data record and the second image data record are therefore compared and/or evaluated in correlative fashion using the geometric arrangement of the detection devices relative to the rail and/or the wheel in order to obtain a very accurate model of the current surface of the wheel, in particular of the tread. From these data, the evaluation unit establishes material displacements in the region of the tread and further appearances of wear of the wheel, for example. Preferably, to this end, the currently established data are compared, for example, to known data from the database, for example to such data that were detected in respect of the same wheel at another—earlier—time.

Preferably, at least the first electromagnetic radiation source, the first detection device and the second detection device of the first measurement unit are arranged in a common first housing. Preferably, at least the first electromagnetic radiation source is a laser diode with a lens system, arranged in front of it, for producing an expanded projection and the pattern. Preferably, the radiation source is arranged between the first detection device and the second detection device in the first housing.

The first electromagnetic radiation source, the first detection device and the second detection device are preferably adjusted in such a way that the first region comprises at least a part of the tread and at least a part of the wheel flange of the wheel. Consequently, the first pattern is projected at least onto a part of the tread and at least onto a part of the wheel flange of the wheel.

The detection devices, in particular the first detection device and the second detection device, are formed as cameras, for example, which are able to detect, in particular, the radiation reflected by the wheel, in particular the first pattern, of the first radiation source. To this end, the wavelength range of the first radiation source is matched to the detectable wavelength range of the first detection device and the second detection device.

Moreover, provision is further made for the system to comprise at least one readout unit for a wheel transponder, e.g., for an RFID chip or a barcode, and/or a wheel load detection unit for measuring the wheel load of the wheel and/or a vibration monitoring unit for detecting vibrations of the wheel.

Preferably, the first measurement unit is configured in such a way that a projection of a first pattern using the first electromagnetic radiation source and a detection of the first pattern using the first detection device and using the second detection device are implemented simultaneously, at least at a trigger time. The first measurement unit has at least one means with which a projection of a first pattern using the first electromagnetic radiation source and a detection of the first pattern using the first detection device and using the second detection device are triggerable at the same time, at least at a trigger time. The trigger time is determined by the time at which the passing wheel or standing wheel of a rail vehicle is situated at the position on the rail with which the first radiation source, the first detection device and the second detection device are adjusted in order to produce the first region there by way of the projection.

The accuracy of the calculation of the properties of the wheel can be significantly increased within the scope of the evaluation by detecting the first pattern twice in the first region by way of a first detection device and by way of a second detection device.

In order to further increase the measurement accuracy of the system, in particular, provision is made according to a first configuration for the first system part to comprise a second measurement unit for a second region on the wheel and/or a third measurement unit for a third region on the wheel.

Preferably, the second measurement unit and/or the third measurement unit have an identical form and configuration to the first measurement unit. The first measurement unit, the second measurement unit and the third measurement unit—to the extent they are present—are aligned with different regions on the wheel. The first measurement unit is aligned with the first region, the second measurement unit is aligned with a second region and the third measurement unit is aligned with a third region of the wheel. Each measurement unit, i.e., the first measurement unit, the second measurement unit and the third measurement unit, comprises at least one first electromagnetic radiation source for projecting a pattern, a first detection device and a second detection device.

Preferably, each measurement unit is configured in such a way that there simultaneously is a projection of a pattern into the corresponding region and the detection by way of the respective first detection device and the second detection device at a trigger time. The first detection device and the second detection device of a measurement unit are aligned at different angles in relation to the region assigned to the measurement unit in such a way that a detection of the pattern projected in this region is possible using both detection units. Advantageously, the first region, the second region and the third region do not intersect.

In a preferred embodiment with three measurement units, provision is consequently made for the first measurement unit to have at least one first electromagnetic radiation source, at least one first detection device and at least one second detection device. Using the first electromagnetic radiation source, a first pattern is projectable into at least one first region onto a standing or passing wheel. The second measurement unit comprises at least one second electromagnetic radiation source, at least one third detection device and at least one fourth detection device, wherein a second pattern is projectable using the second radiation source into at least the second region onto the wheel standing on, or passing along, the rail. The third measurement unit comprises at least one third electromagnetic radiation source, at least one fourth detection device and at least one fifth detection device, wherein a third pattern is projectable using the third radiation source in at least the third region onto the wheel passing along, or standing on, the rail.

Preferably, the first pattern and/or the second pattern and/or the third pattern are identical. Provision is also made for the first pattern and/or the second pattern and/or the third pattern to be different.

Advantageously, the first measurement unit is arranged in a first housing, the second measurement unit is arranged in a second housing and the third measurement unit is arranged in a third housing. As already explained in relation to the first radiation source, the electromagnetic radiation sources are preferably formed as lasers. By way of example, the second radiation source and the third radiation source have an embodiment identical to the first radiation source, i.e., also comprise, for example, at least one lens and/or a pattern stop, etc. Particularly preferably, provision is made for the first region of the first measurement unit to comprise at least a part of the tread and a part of the wheel flange of the wheel. In particular, the first region is arranged on a first half of the circumference of the wheel, in particular the half of the circumference facing away from the movement direction. Further, provision is preferably made for the second region of the second measurement unit to comprise at least a part of the tread of the wheel and a part of the wheel flange of the wheel. In particular, the second region is arranged on a second half of the circumference of the wheel, in particular the half of the circumference facing the movement direction. Further preferably, provision is made for the third region of the third measurement unit to comprise at least a part of the inner wheel flank and a part of the wheel flange.

According to a further configuration of the system, provision is preferably made for the first measurement unit and the second measurement unit to be arranged on a first side of a rail and for the third measurement unit to be arranged on a second side of the rail, wherein, in particular, the second side is the inner side of the rail. Here, the inner side of the rail is the part of the rail assigned to the second rail extending in parallel in a track. Consequently, the third measurement unit is arranged between the first rail and the second rail of a track.

As a result of the third measurement unit preferably detecting at least a part of the inner wheel flank with its third region, the wheel position relative to the rail or the axle position of the wheelset relative to the rail is determinable using the image data record of the third measurement unit.

In order to further increase the detection accuracy for the surface of the wheel, provision is made according to a further embodiment for the first system part to be configured in such a way that the projection and detection are implemented, at least at the same time, with the first measurement unit and/or with the second measurement unit and/or with the third measurement unit. The system comprises at least one means, with which the projection and detection are triggerable, at least simultaneously, with the first measurement unit and/or with the second measurement unit and/or with the third measurement unit. Consequently, in the preferred exemplary embodiment with three measurement units, a pattern is respectively projected simultaneously in the first region, in the second region and in the third region on the wheel at a trigger time and the respective pattern is detected by two detection devices in each case and the produced image data records are supplied to an evaluation unit. The properties of the wheel and, inter alia, the position of the wheel relative to the rail can be calculated very precisely on the basis of the data obtained thus using the evaluation unit.

In relation to the prior art, the present disclosure is advantageous in that a pattern projected into the respective region is always detected using two detection devices, as a result of which the accuracy of the data, and hence the knowledge about the current geometric properties of the wheel and the wear state, are increased.

According to a further embodiment, the accuracy of the system can be further increased by virtue of the first measurement unit and/or the second measurement unit and/or the third measurement unit comprising at least one further electromagnetic radiation source and by virtue of electromagnetic radiation being projectable onto the wheel by the further radiation source, into the first region in the case of the first measurement unit, into the second region in the case of the second measurement unit and into the third region in the case of the third measurement unit.

Consequently, provision is made for each measurement unit, i.e., the first measurement unit and/or the second measurement unit and/or the third measurement unit, to have a further electromagnetic radiation source in addition to the respective first electromagnetic radiation source for projecting a pattern, electromagnetic radiation being projectable into the respective region assigned to the respective measurement unit by means of said further electromagnetic radiation source. By way of example, the electromagnetic radiation of the further radiation source can be formed to illuminate the respective region, in particular at the trigger time.

Further, provision is also made for respectively one further pattern to be projectable into the respective region using the further radiation source. To this end, the further radiation source, in a manner identical to the first radiation source, too, comprises a lens for expansion and/or a lens with a pattern and/or a pattern stop, for example.

In the preferred embodiment with three measurement units, for example, the first measurement unit comprises a second radiation source, the second measurement unit comprises a fourth radiation source and the third measurement unit comprises a sixth radiation source.

According to a further embodiment of the system, provision is made for at least one radiation source in the system to be formed as an infrared laser. Preferably, provision is made for all radiation sources of the system to be formed as infrared lasers, i.e., to emit radiation in a spectral range between 1 mm and 780 nm or a frequency range from 300 GHz to 400 THz. Then, the detection units are accordingly formed in such a way that they can detect the infrared radiation reflected by the wheel and are able to convert this into image data records.

In the preferred embodiment with three measurement units, the first radiation source, the second radiation source, the third radiation source, the fourth radiation source, the fifth radiation source and the sixth radiation source are consequently formed as infrared lasers.

In order to increase the spectrum of application of the system, provision is made according to a further embodiment for the first system part to comprise at least one braking detection device and for the braking detection device to be configured and formed in such a way that at least one brake disk of a standing or passing rail vehicle is detectable. The braking detection device comprises at least one measurement unit. Provision is made for the measurement unit of the braking detection device to be embodied like the measurement units for the wheel, with the difference that a measurement unit is aligned with a region on a brake disk.

Preferably, a braking detection device comprises at least two, preferably three, identical measurement units. In particular, provision is made for the system to comprise two, preferably three, braking detection devices, with which all two or three brake disks of a wheelset are detectable and the geometric properties of which are establishable. In particular, the evaluation is implemented using the evaluation unit of the system. Consequently, the braking detection device or the braking detection devices are arranged in the system and on the rail in such a way that they are aligned to detect the brake disks of a passing train. All properties described for the measurement units or system parts apply accordingly to the braking detection device, too.

In order to precisely set the trigger time for all measurement units, provision is made according to a further embodiment for the first system part to comprise at least one first trigger device and at least one second trigger device, for the first trigger device and the second trigger device to be aligned with the wheel standing on, or passing along, the rail and for a projection and detection with the first measurement unit and/or the second measurement unit and/or the third measurement unit to be triggerable by the first trigger unit and the second trigger unit. Preferably, a projection and detection with all three measurement units are triggerable simultaneously or are triggered simultaneously—at the trigger time—by the two trigger units.

Advantageously, provision is made for the first trigger unit and the second trigger unit to be spaced apart from one another in the rail longitudinal direction. Preferably, one trigger unit detects a part of the circumference of the wheel facing the movement direction and the second trigger unit detects the part of the circumference of the wheel facing away from the movement direction. The time at which a trigger signal is generated by the two trigger units is the trigger time, which is preferably identical for all three measurement units, i.e., for at least three radiation sources and at least six detection devices.

According to a last configuration, the system can be improved by virtue of a second system part being comprised, by virtue of the second system part having an identical embodiment to the first system part and by virtue of the second system part being arranged on the second rail of the track. Preferably, the second system part is embodied and configured in such a way that a second wheel of a rail vehicle, preferably the second wheel assigned to the wheelset of the first wheel, is detectable.

Consequently, a first system part and a second system part allow simultaneous detection of the first wheel and the second wheel of a wheelset and determination of the properties. Preferably, properties of the first wheel and of the second wheel are detected simultaneously at a trigger time by the first system part and the second system part. Moreover, statements in respect of the position of the first wheel and of the second wheel relative to one another can be made by way of the software-controlled evaluations since the assembly positions and alignment of the measurement units of the first system part and of the second system part are fully known, even relative to one another. To this end, provision is made for the alignment and assembly positions of all measurement units and/or radiation sources and/or detection units, in particular also relative to one another, to be taken into account during the evaluation by the evaluation unit in order to establish properties of the wheelset.

The disclosure further provides a method for establishing properties of a wheel of a rail vehicle, wherein the method is carried out, in particular, using a system as described above. The method is characterized by the following method steps:
projecting at least a first at least two-dimensional pattern into at least a first region onto a first wheel arranged on, i.e., passing along or standing on, a rail using a first electromagnetic radiation source,
detecting the first pattern in the first region by at least a first detection device and producing at least a first image data record,
calculating a model data record using the first image data record, wherein the model data record is representable as a three-dimensional, at least partial model of the first wheel.

Initially, a two-dimensional, planar pattern is projected into a first region onto a standing or passing first wheel of a rail vehicle using a first electromagnetic radiation source, formed, in particular, as a laser, particularly preferably as an infrared laser. This pattern is detected by a first detection device aligned with the first region and a first image data record is produced. Subsequently, a model data record is calculated from this image data record, in particular using an evaluation unit formed as a computer. The model data record is calculated at least from the first image data record in such a way that the model data record is representable as an at least partly three-dimensional model of the first wheel. In particular, the position of the detected data points of the two-dimensional pattern in space is calculated on the basis of the image data record by means of triangulation such that each data point is assigned to a certain position in space, in particular a location on the wheel, in particular by way of polar coordinates. As a result of this assignment, in particular by way of polar coordinates, the model data record images an at least partly three-dimensional model of the first wheel and it is representable as such. Any geometric properties of the wheel of the rail vehicle are calculated on the basis of the model data record, for example the height and width of the wheel flange, the profile of the tread, etc.

According to a first embodiment of the method, provision is made for the following method step to additionally be carried out:
calculating a profile data record using the model data record, wherein the profile data record is calculated by transforming the model data record into a plane and wherein the profile data record is representable as a two-dimensional profile of the first wheel.

Consequently, the profile data record is calculated from all data of the model data record. Preferably, the measurement data points of the model data record are transformed, i.e., converted, into a two-dimensional plane and hence an averaged—using all available measurement data points on the wheel circumference—two-dimensional profile of the first wheel is calculated, in particular containing the tread and the wheel flange. Consequently, the profile data record contains the three-dimensional data of the model data record which have been converted or transformed into a common, averaged profile—in two dimensions.

The properties of the wheel, for example the height and width of the wheel flange, the wheel width in the profile region and the wheel running circle diameter or the wheel back-to-back distance can advantageously be determined on the basis of the profile data record.

Advantageously, provision is furthermore made for the profile data record, in particular using the evaluation unit, to be compared to at least one further profile data record that is stored in a database and for changes in the geometric properties of the wheel to be established on the basis of this comparison. By way of example, the further profile data record is a profile data record of this wheel, detected and stored at another, e.g., earlier, time.

According to a further embodiment, the accuracy of the method can be further increased by virtue of provision being made for at least the following further method steps to be comprised:
projecting at least a second at least two-dimensional pattern in at least a second region onto the first wheel arranged on, i.e., standing on or passing along, the rail using a second electromagnetic radiation source,
detecting the second pattern in the second region by at least one second detection device and producing at least one first image data record of the second region,
calculating the first model data record with additional use of the first image data record of the second region.

Consequently, the model data record is calculated using the first image data record of the first region and the first image data record of the second region. Specifically, this means that triangulation is used to assign a position in space to the image data records of the first region and of the second region, specifically the measurement points. In particular, this position in space is described by way of polar coordinates. The first region and the second region do not intersect, and so different regions of the model data record, i.e., of the three-dimensional model of the wheel, are calculated from the first image data record of the first region and the first image data record of the second region.

According to a further embodiment, provision is particularly preferably made for the following method steps to be comprised:
projecting at least a third at least two-dimensional pattern into at least a third region onto the first wheel arranged on, i.e., standing on or passing along, the rail using a third electromagnetic radiation source,
detecting the third pattern in the third region by at least one third detection device and producing at least one first image data record of the third region,
calculating the first model data record using the first image data record of the third region, wherein the model data record is representable as a three-dimensional, at least partial model of the wheel.

Particularly preferably, the model data record is consequently calculated using the first image data record of the first region, the first image data record of the second region and the first image data record of the third region. The first region, the second region and the third region preferably do not intersect, and so different regions of the model data record, i.e., of the three-dimensional model of the wheel, are calculated with the three image data records.

Preferably, provision is made for the detection of the first pattern, the detection of the second pattern and the detection of the third pattern to be implemented at the same time. Consequently, the detection is implemented at a common trigger time such that the data underlying the model data record were detected at the same time.

The accuracy of the method is further increased by virtue of, according to a further embodiment, provision being made for a second image data record to be respectively detected for the first region and/or for the second region and/or for the third region, in each case using a further detection unit, and provision being made for each second image data record to be used for calculating the first model data record.

Preferably, this respective second image data record is detected at the same time as the first image data record, i.e., at the trigger time. Consequently, a first image data record and a second image data record are available for each region at the trigger time, the first model data record being calculated on the basis thereof. The accuracy of the method is increased by the redundant detection of each region.

Further, provision is made according to an embodiment of the method for the model data record of the first wheel and the model data record of a second wheel of a wheelset and the geometric arrangement and alignment of the radiation sources and/or detection units to be correlated with one another in order to determine the position of the first wheel of a wheelset relative to the second wheel. Further, provision is made for the profile data record of a first wheel also to be correlated with the profile data record of a second wheel of a wheelset and the geometric arrangement and alignment of the radiation sources and/or detection units in order to establish the position, for example different measurement distances, of the first wheel relative to the second wheel.

The system disclosed herein comprises at least one first system part, which is arranged on at least one first rail of a track. The first system part comprises at least a first measurement unit, which has at least a first electromagnetic radiation source and at least a first detection device. The first radiation source is formed and configured, in particular arranged on the rail, in such a way that a first pattern is projectable in at least one first region onto a wheel, of a rail vehicle, standing on the rail or passing along the rail—i.e., a wheel arranged on the rail—by means of the first radiation source. The projected first pattern is a planar, at least two-dimensional pattern. The first detection device is formed and configured, in particular arranged on the rail, in such a way that the first pattern in the first region on the wheel tire is detectable using the first detection device and said first pattern is convertible into digitally processable image data.

### BRIEF DESCRIPTION OF THE DRAWINGS

In detail, there now are a multiplicity of options for designing and developing the system and the method. In this respect, reference is made to the following description of preferred exemplary embodiments in conjunction with the drawing. In the drawing:

FIG. 1 shows an exemplary embodiment of a system in a perspective view,

FIG. 2 shows an exemplary embodiment of a first system part in a side view,

FIG. 3 shows an exemplary embodiment of a system in a plan view,

FIG. 4 shows an exemplary embodiment of a system in a side view,

FIG. 5 shows an exemplary embodiment of a system in a side view,

FIG. 6 shows an exemplary embodiment of a system in a view from the front,

FIG. 7 shows an exemplary embodiment of a system with a projection in a plan view,

FIG. 8 shows a detailed view of a wheel during the projection,

FIG. 9a shows a schematic flow chart of a method,

FIG. 9b shows a schematic flow chart of a method,

FIG. 9c shows a schematic flow chart of a method,

FIG. 10 shows an overview of the geometric properties of the wheel,

FIG. 11 shows an exemplary three-dimensional representation of a model data record, and

FIG. 12 shows an exemplary two-dimensional representation of a profile data record.

### DETAILED DESCRIPTION

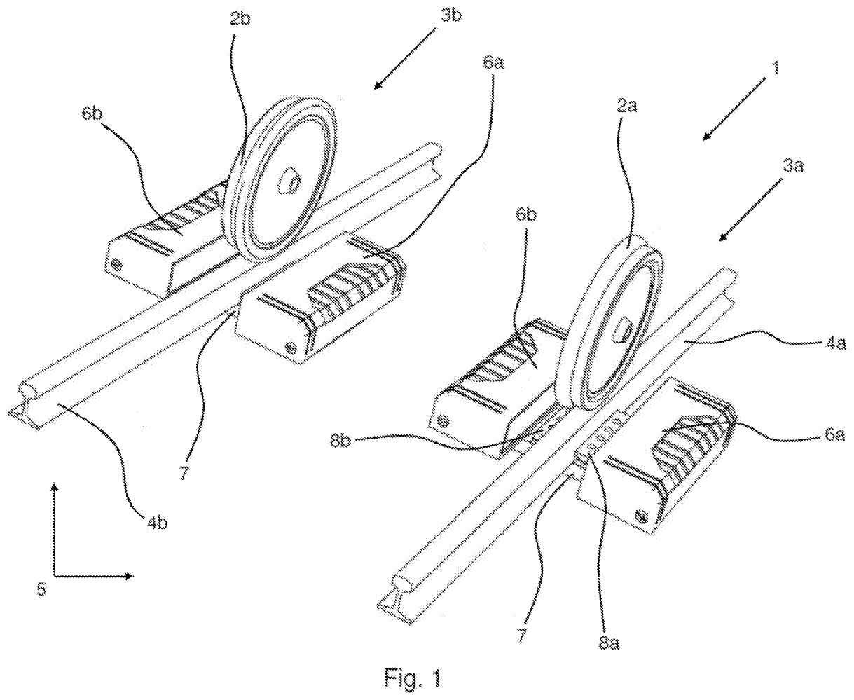

FIG. 1 shows an exemplary embodiment of a system 1 for establishing properties, in particular geometric properties, of a wheel 2—first wheel 2a, second wheel 2b—of a rail vehicle—not illustrated. The system 1 comprises a first system part 3a which is arranged on a rail 4—first rail 4a, second rail 4b—of a track 5. FIG. 1 shows that the first system part 3a comprises a first outer housing 6a and a second outer housing 6b. The first outer housing 6a and the second outer housing 6b are arranged on an assembly plate 7, which passes under the rail 4a and which is fastened to the rail base of the rail 4a by means of tensioning plates 8a, 8b. The first outer housing 6a and the second outer housing 6b are designed in such a way that the upper edge lies level with the rail upper edge or therebelow.

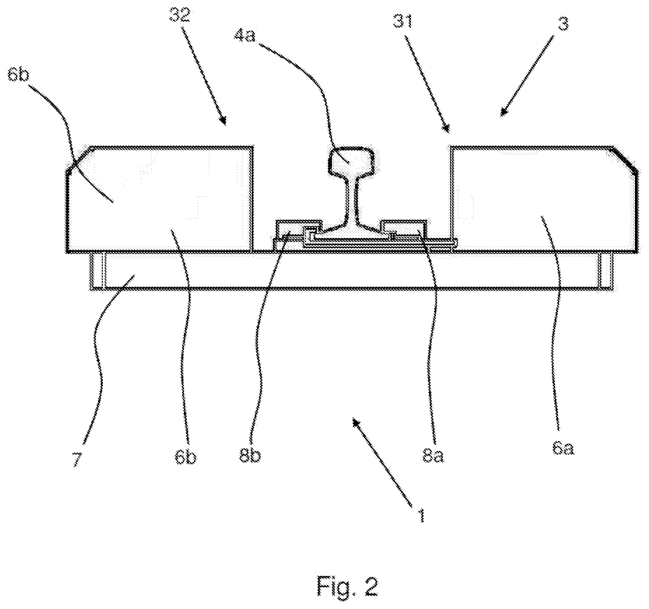

FIG. 2 shows the first system part 3a in a side view with a cut first rail 4a. The assembly plate 7 passes below the rail 4a and is fastened to the rail base of the rail 4a by means of tensioning plates 8a, 8b. The outer housings 6a and 6b of the system 1 are fastened to the assembly plate 7 and, with their upper edge, are situated level with the upper edge of the rail 4a.

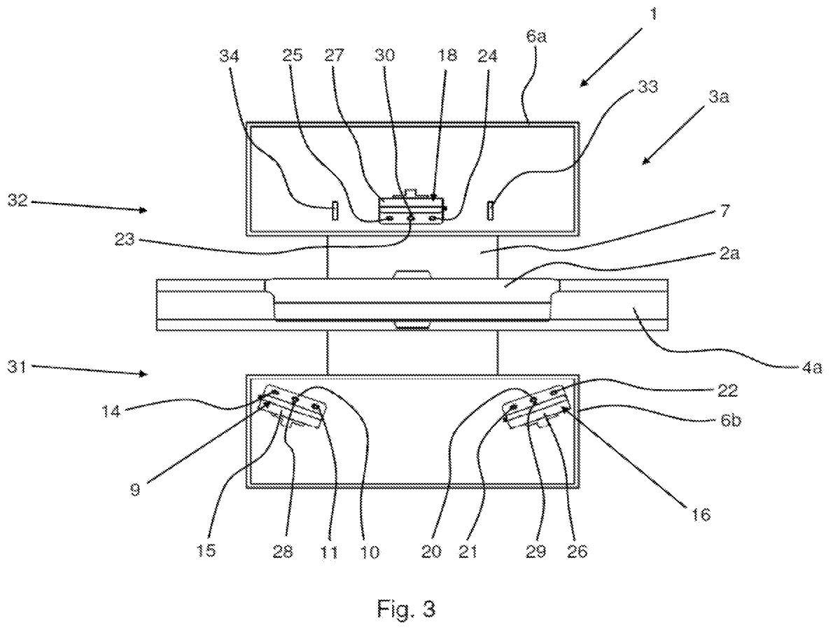

FIG. 3 shows a plan view of an exemplary embodiment of a system 1, in particular of a first system part 3a. The first system part 3a comprises at least one first measurement unit 9, which has a first electromagnetic radiation source 10 and a first detection unit 11. The first electromagnetic radiation source 10 is embodied as an infrared laser in this exemplary embodiment, wherein the first detection device 11 is embodied as a camera which is able to detect the infrared rays that are reflected by the wheel 2 arranged on the rail.

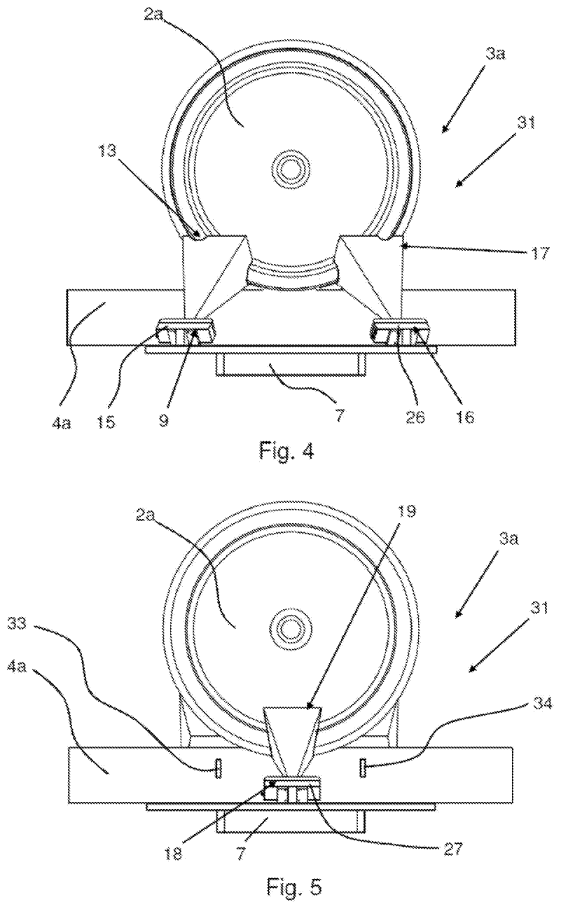

The exemplary embodiment according to FIG. 3 can be gathered from FIGS. 4 to 7, with the projected electromagnetic radiation, expanded laser beams imaging a pattern in this exemplary embodiment, being illustrated in exemplary fashion.

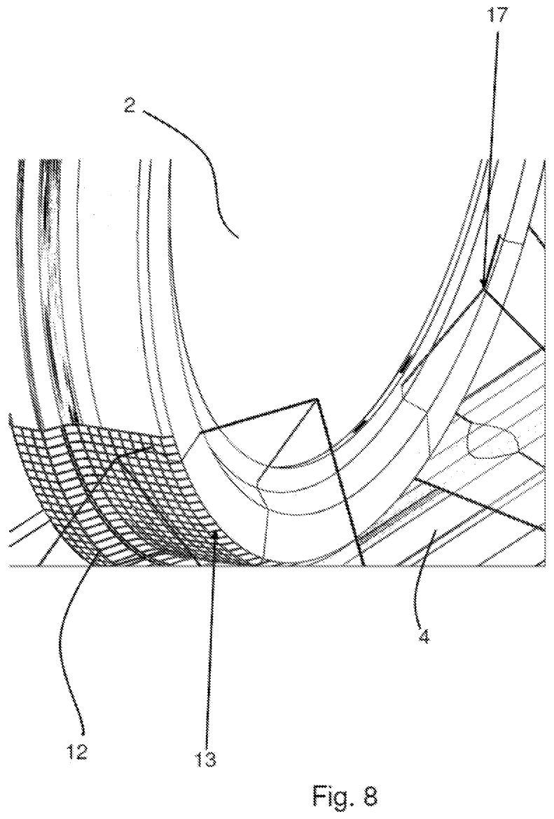

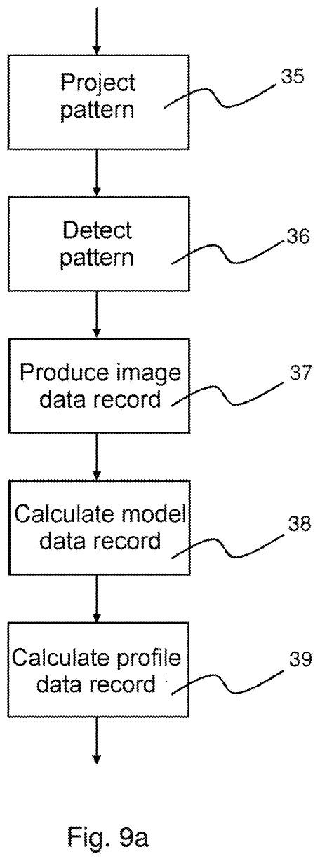

A detailed recording of the projection in the first region 13 can be gathered from FIG. 8, where a first pattern 12 is projected onto the wheel 2 in the first region 13. The first detection device 11 shown in FIGS. 3 and 7 detects the first pattern 12 in the first region 13 and produces a first image data record therefrom. According to FIG. 8, the first pattern 12 is a two-dimensional planar pattern 12, in this case in the form of a regular mesh which is projected onto the three-dimensional surface of the wheel 2 and distorted.

According to FIG. 3, the first measurement unit 9 further comprises a second detection device 14, wherein the second detection device 14 is formed and configured in such a way that the first pattern 12 in the first region 13 on the wheel 2 is detectable (see also FIG. 4 and FIG. 7). The first electromagnetic radiation source 10, the first detection device 11 and the second detection device 14 of the first measurement unit 9 are housed in a common housing 15.

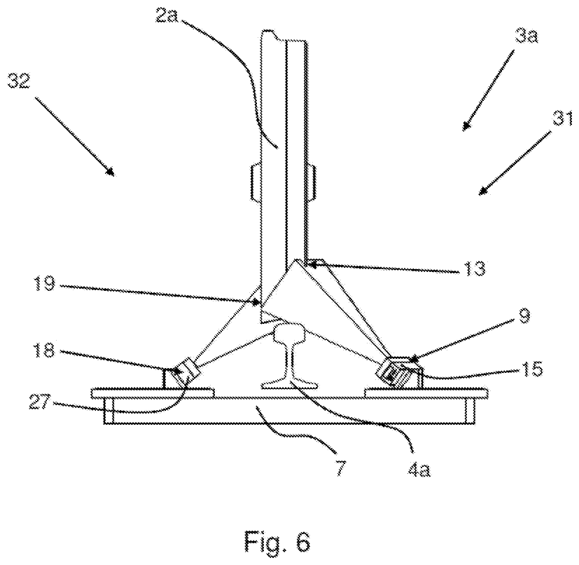

The first system part 3a of the system 1 further comprises a second measurement unit 16 for a second region 17 on the wheel 2 (see FIG. 3 and FIG. 4) and a third measurement unit 18 for a third region 19 on the wheel 2 (see FIG. 5 and FIG. 7).

The second measurement unit 16 comprises a second electromagnetic radiation source 20 and a third detection device 21 and a fourth detection device 22. The third measurement unit 18 comprises a third electromagnetic radiation source 23, a fifth detection device 24 and a sixth detection device 25 (see FIG. 3).

The third detection device 21 and the fourth detection device 22 are used to detect the second pattern 12a, projected by the second electromagnetic radiation source 20, in the second region 17 on the wheel 2. The fifth detection unit 24 and the sixth detection unit 25 serve to detect the third pattern 12b, which is projected into the third region 19 on the wheel 2 by the third electromagnetic radiation source 23.

The second measurement unit 16 is arranged in a second housing 26 and the third measurement unit 18 is arranged in a third housing 27. In the assembled state, the first housing 15, the second housing 26 and the third housing 27 are housed within the respective outer housings 6a, 6b (see FIG. 1). In the side regions oriented in the direction of the rail 4a, the outer housings 6a, 6b each have an opening for projection and detection.

According to FIG. 3, the first measurement unit 9 moreover comprises a fourth radiation source 28, the second measurement unit comprises a fifth radiation source 29 and the third measurement unit 18 comprises a sixth radiation source 30, and so each measurement unit 9, 16, 18 comprises a further radiation source 28, 29, 30. The further radiation sources 28, 29, 30 serve to illuminate the respective region 13, 17, 19 and are embodied as infrared lasers.

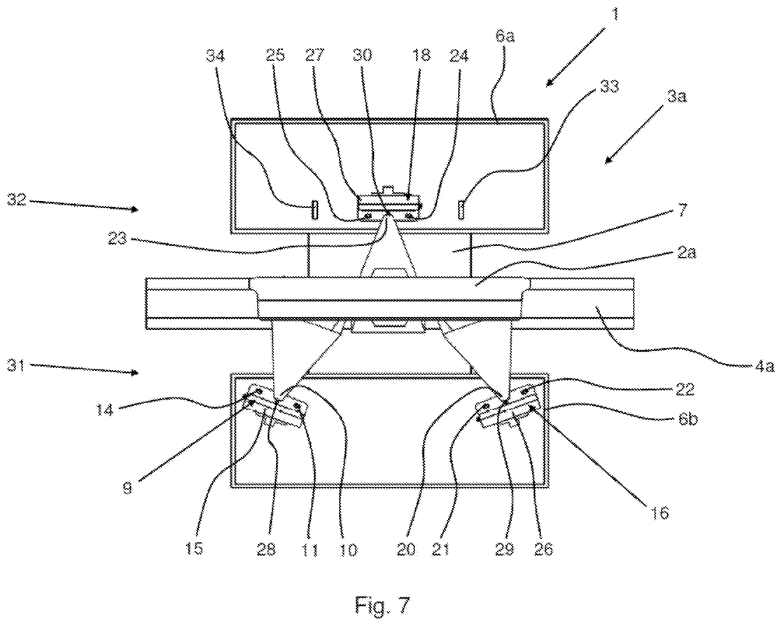

What can be gathered from FIG. 3, FIG. 6 and FIG. 7 is that the first measurement unit 9 and the second measurement unit 16 are arranged on a first side 31 of the rail 4, while the third measurement unit 18 is arranged on a second side 32 of the rail. A first trigger unit 33 and a second trigger unit 34 are arranged on the second side 32 of the rail 4, said trigger units setting the trigger time for the radiation sources 10, 20, 23, 28, 29, 30 and the detection devices 11, 14, 21, 22, 24, 25 according to set criteria such that a projection and detection occur simultaneously in all three regions 12, 17, 19.

What can further be gathered from FIG. 1 is that the system 1 comprises a second system part 3b, which has an identical form to the first system part 3a and which detects the properties of the second wheel 2b.

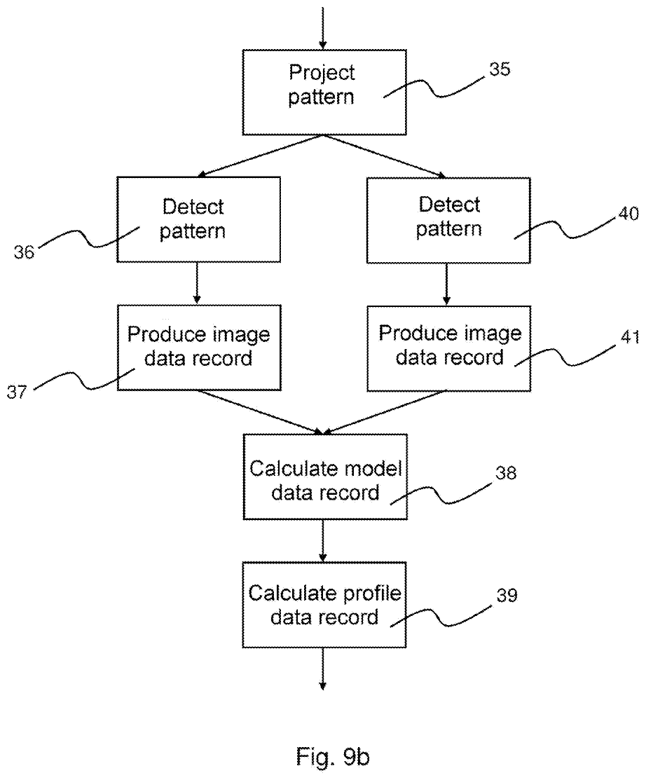

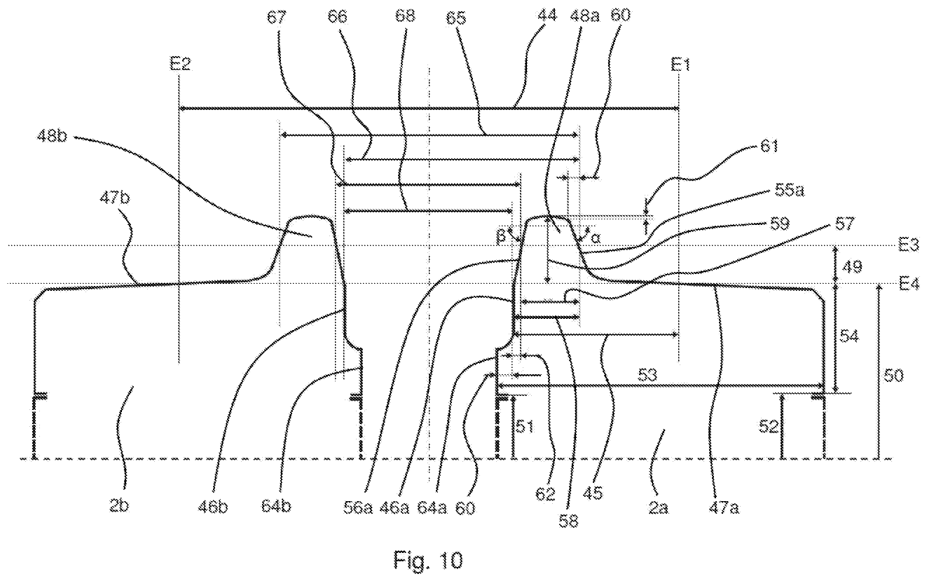

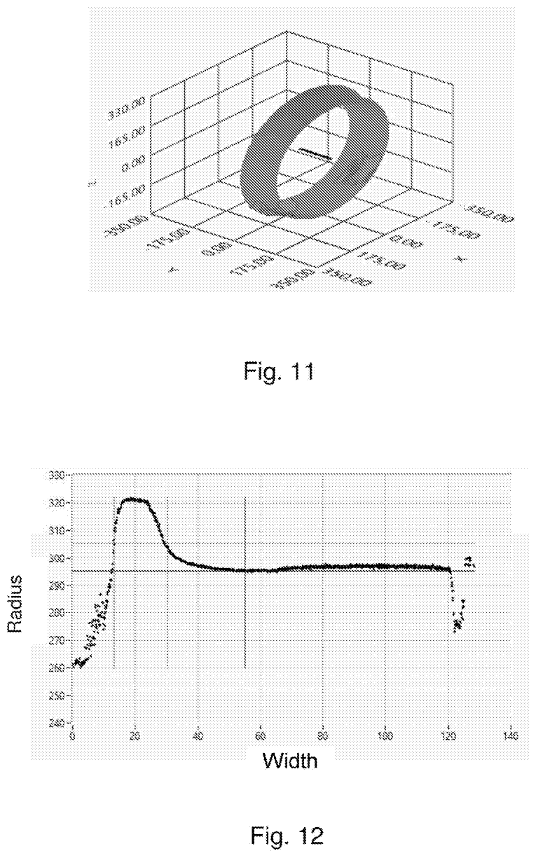

FIG. 9a shows a schematic sequence of an exemplary embodiment of a method for establishing properties of a wheel 2 of a rail vehicle. Initially, there is a projection 35 of at least one first two-dimensional pattern 12 in at least one first region 13 onto a first wheel 2, standing on or passing along the rail 4, using a first electromagnetic radiation source 11. Further, there is a detection 36 of the first pattern 12 in the first region 13 using at least one first detection device 11 and the production 37 of at least one first image data record. A model data record 38 is calculated from the image data record. Also, a profile data record 39 is subsequently calculated from the model data record. The profile data record serves as a basis for determining the geometric properties of the wheel 2, for example the height and width of the wheel flange, the profile of the tread, etc. An exemplary three-dimensional representation of the wheel 2, specifically of a model data record, can be gathered from FIG. 11; an exemplary two-dimensional representation of the profile of the wheel 2 in the region of the tread and the wheel flange, specifically of the profile data record, can be gathered from FIG. 12.

FIG. 9b shows a schematic sequence of an exemplary embodiment of a method, in which the projection 35 of a first at least two-dimensional pattern 12 onto at least one first region 13 of a first wheel 2, passing along or standing on a rail 4, is implemented using an electromagnetic radiation source 10. In addition to detecting 36 the first pattern in the first region 13 using at least one first detection device 11, the first pattern 12 is detected 40 in the first region 13 using at least one second detection device 14, and at least one second image data record of the first region 13 is produced 41. The detection 36 and the detection 40 by means of the first detection device 11 and the second detection device 14 are implemented at the same time. After producing 37 the first image data record of the first region 13 and producing 41 the second image data record of the first region 13, the model data record is calculated 38 and the profile data record is subsequently calculated 39.

FIG. 9c shows a schematic sequence of an exemplary embodiment of a method for determining properties of a wheel 2, in which there initially is a projection 35 of at least one first pattern 12 in at least one first region 13 and a projection 42 of a second pattern 12a in a second region 17 and a projection 43 of a third pattern 12c in a third region 19. Further, the pattern is detected 36 in each of the regions 13, 17, 19 using a first detection device 10, 21, 24 and said pattern is detected 40 using a second detection device 14, 21, 25, and a first image data record and a second image data record are produced 37, 41 for each region 13, 17, 19. Finally, the model data record is calculated 38 on the basis of all first and second image data records produced, and a profile data record is calculated 39 from the model data record.

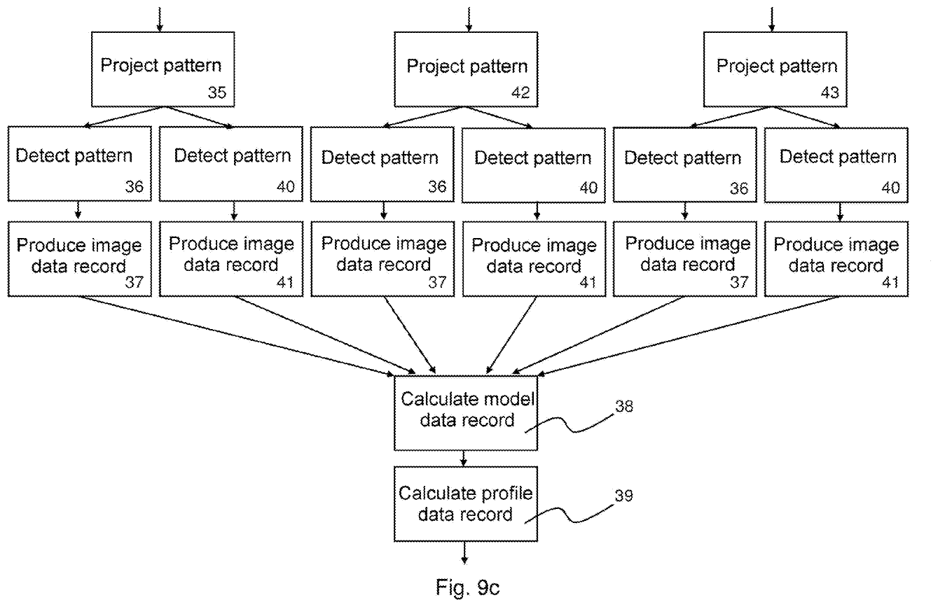

FIG. 10 shows an overview of the establishable geometric properties of the first wheel 2a and of the second wheel 2b and of the properties of the first wheel 2a relative to the second wheel 2b, i.e., of the wheelset. The system, in particular the evaluation unit, and/or the method are, in particular, formed and configured in such a way that all dimensions illustrated in FIG. 10 are establishable and/or established, either individually or in combination. Consequently, the system and/or the method are configured to establish all dimensions illustrated in FIG. 10, either individually or in combination. In particular, the dimensions illustrated in FIG. 10 are established from the profile data record and/or the correlation of the profile data record of the first wheel 2a with the profile data record of the second wheel 2b and the arrangement of the measurement units 9, 16, 18 and the components thereof.

The measuring circle plane distance 44 specifies the distance between the measuring circle plane E1 of the first wheel 2a and the measuring circle plane E2 of the second wheel 2b. The measuring circle plane E1 and the measuring circle plane E2 are arranged in such a way that the axis of rotation of the first wheel 2a and the axis of rotation of the second wheel 2b pass through the measuring circle plane E1 and the measuring circle plane E2 in substantially orthogonal fashion. Further, the measuring circle plane E1 and the measuring circle plane E2 are arranged in such a way that they are spaced apart from the inner flank 46a of the first wheel 2a or the inner flank 46b of the second wheel 2b with the measuring circle plane distance-x 45 of between approximately 60 mm and 65 mm. The intersecting circle of the measuring circle plane E1, E2 with the tread 47a, 47b defines the contact ring or contact point of the wheel 2a, 2b on a rail 4a, 4b.

The dimensions on the wheel flange 48a, 48b are determined in a sectional plane E3, which is arranged orthogonal to the measuring circle plane E1, E2 and which, in the illustrated cross section, is spaced apart from the point of intersection of the measuring circle plane E1, E2 with the tread 47a, 47b with a measuring circle plane distance-y 49 of approximately 10 mm.

The diameter 50 of the wheel 2a is likewise determined in the measuring circle plane El. Further important dimensions of the wheel are the wheel body inner diameter 51 and the wheel body outer diameter 52, as well as the wheel tire width 53. The height 54 of the wheel tire is determined in the measuring circle plane E1 between the lower edge of the wheel tire and the point of intersection with the tread 47a.

The sectional plane E3 forms the basis for the dimensions of the wheel 2a in the region of the wheel flange 48a. The points of intersection—in the cross section—of the sectional plane E3 with the inner flank 55a of the wheel flange 48b and the outer flank 56a of the wheel flange 48a form the starting point for the subsequent dimensions. A first wheel flange width 57 is determined as the distance between the points of intersection of the wheel flange 48a in the sectional plane E3. A second wheel flange width 58 is determined between the inner point of intersection of the wheel flange 48a with the sectional plane E3 and the inner flank 46a. A wheel flange height 59 is determined from a plane E4, in which the point of intersection of the measuring circle plane E1 with the tread 47a lies, to the upper edge of the wheel flange. The inclination of the inner flank 55a and of the outer flank 56a are described by the angles α and β. Alternatively, the inclination of the inner flank 55a can be specified by the distance 60 emerging from the inner point of intersection of the sectional plane E3 with the wheel flange 48a at its inner flank 55a and the point of intersection of the inner flank 55a at a distance 61 of between 0.9 mm and 2 mm from the upper edge of the wheel flange 48a. The flank dimension 62 specifies the distance between the outer point of intersection of the sectional plane E3 with the outer flank 5 6a of the wheel flange 48a and the inner flank 46a. The flank dimension 63 specifies the distance between the guide flank 64a and the inner flank 46a.

The system and/or the method are formed and configured, in particular, in such a way that the dimensions illustrated in FIG. 10 are also establishable and/or established as geometric properties of the first wheel 2a relative to the second wheel 2b, in particular by correlating the first profile data record, the second profile data record and the geometric arrangement of the measurement units 9, 16, 18. Consequently, the system and/or the method are configured to establish the dimensions illustrated in FIG. 10, either individually or in combination, as geometric properties of the first wheel 2a relative to the second wheel 2b, in particular by correlating the first profile data record, the second profile data record and the geometric arrangement of the measurement units 9, 16, 18. As a result of the arrangement of the measurement units 9, 16, 18 of the first system part 3a and of the second system part 3b relative to one another being known in a system, these information items are utilizable by the evaluation unit for appropriate evaluation purposes and are used for calculation purposes.

The measuring circle plane distance 44—as already explained—specifies the distance between the measuring circle plane E1 of the first wheel 2a and the measuring circle plane E2 of the second wheel 2b. The gage dimension 65 specifies the distance between the points of intersection of the inner flanks 55a, 55b with the sectional plane E3. The guide dimension 66 can be determined on both sides and defines the distance between the point of intersection of the sectional plane E3 with the inner flank 55a of the first wheel 2a and the inner flank 46b of the second wheel 2b. The guide circle distance 67 defines the distance between the points of intersection of the sectional plane E3 with the outer flanks 56a and 56b. The back-to-back distance 68 defines the distance between the inner flanks 46a and 46b of the first wheel 2a and of the second wheel 2b.

FIG. 11 shows, in exemplary fashion, the illustrated data of the model data record, specifically an at least partial model of the wheel 2. The regions illustrated in framed fashion are actually supported by data, i.e., as data calculated from the image data records. The other regions have been extrapolated. The dimensions along the axes x, y, z are specified in millimeters. The model data record comprises a multiplicity of measurement data points in a three-dimensional coordinate system, preferably as polar coordinates. The measurement data points image the surface of the wheel 2a in the detected region 13, 17, 19.

FIG. 12 shows, in exemplary fashion, the illustrated data of a profile data record, specifically a two-dimensional profile of the wheel 2 in the region of the tread 47 (see FIG. 10) and of the wheel flange 48. The wheel width is illustrated along the x-axis and the radius of the wheel 2a is plotted on the y-axis, respectively in millimeters. In FIG. 12, all measurement data points of the model data record from FIG. 11 have been transformed into a two-dimensional Cartesian coordinate system such that an averaged profile of the wheel 2 according to FIG. 12 arises in the region of the tread 47, the wheel flange 48 and the inner flank 46. Further, the data contain the diameter 50 of the wheel 2a.

1. A system for establishing properties of at least one wheel of a rail vehicle, comprising at least one first system part, wherein the first system part is arrangeable at at least one rail of a track, wherein the first system part comprises at least one first measurement unit, wherein the first measurement unit comprises at least one first electromagnetic radiation source and at least one first detection device, wherein the first radiation sourced is formed and configured in such a way that a first pattern is projectable in at least one first region onto the wheel, arranged on the rail, of a rail vehicle by means of the first radiation source, wherein the first detection device is formed and configured in such a way that the first pattern in the first region on the wheel is detectable by means of the first detection device and wherein the first pattern is an at least two-dimensional pattern, wherein the first measurement unit comprises a second detection device and wherein the second detection device is formed and configured in such a way that the first pattern in the first region on the wheel is detectable by means of the second detection device.

2. The system as claimed in claim 1, wherein the first system part comprises a second measurement unit for a second region on the wheel and/or a third measurement unit for a third region on the wheel.

3. The system as claimed in claim 1, wherein the first measurement unit and the second measurement unit are arranged on a first side of the rail and the third measurement unit is arranged on a second side of the rail, in particular, the second side is the inner side of the rail.

4. The system as claimed in claim 1, wherein the first system part is configured in such a way that the projection and detection are implemented at the same time, at least with the first measurement unit and/or with the second measurement unit and/or with the third measurement unit.

5. The system as claimed in claim 1, wherein the first measurement unit and/or the second measurement unit and/or the third measurement unit comprise at least one further electromagnetic radiation source and wherein electromagnetic radiation is projectable onto the wheel by the further radiation source, into the first region in the case of the first measurement unit, into the second region in the case of the second measurement unit and into the third region in the case of the third measurement unit.

6. The system as claimed in claim 1, wherein at least one radiation source is formed as an infrared laser.

7. The system as claimed in claim 1, wherein the first system part comprises at least one braking detection device and wherein the braking detection device is configured and formed in such a way that at least one brake disk of a rail vehicle arranged on the rail is detectable.

8. The system as claimed in claim 1, wherein the first system part comprises at least one first trigger device and one second trigger device, wherein the first trigger unit and the second trigger unit are aligned with the wheel arranged on the rail and wherein a projection and detection with the first measurement unit and/or the second measurement unit and/or the third measurement unit are triggerable by the first trigger unit and the second trigger unit.

9. The system as claimed in claim 1, wherein a second system part is comprised, wherein the second system part has an identical form to the first system part and wherein the second system part is arrangeable at the second rail of the track.

10. A method for establishing properties of a wheel of a rail vehicle, in particular using a system as claimed in claim 1, characterized by the following stepsthe method comprising:
projecting at least one first at least two-dimensional pattern into at least one first region onto a first wheel arranged on the rail using a first electromagnetic radiation source,
detecting the first pattern in the first region by at least one first detection device and producing at least one first image data record,
calculating a model data record using the first image data record, wherein the model data record is representable as a three-dimensional, at least partial model of the first wheel.

11. The method as claimed in claim 10, further comprising,
calculating a profile data record using the model data record, wherein the profile data record is calculated by transforming the model data record into a plane and wherein the profile data record is representable as an at least partial, two-dimensional profile of the first wheel.

12. The method as claimed in claim 11, wherein the profile data record is compared to at least one further profile data record that is stored in a database and wherein changes in the geometric properties of the wheel are established on the basis of this comparison.

13. The method as claimed in claim 10 further comprising:
projecting at least a second at least two-dimensional pattern into at least one second region onto a first wheel arranged on the rail using a second electromagnetic radiation source,
detecting the second pattern in the second region by at least one second detection device and producing at least one first image data record of the second region,
calculating the first model data record with additional use of the first image data record of the second region.

14. The method as claimed in claim 10, wherein further comprising:
projecting at least a third at least two-dimensional pattern into at least a third region onto a first wheel arranged on a rail using a third electromagnetic radiation source,
detecting the third pattern in the third region by at least one third detection device and producing at least one first image data record of the third region,
calculating the first model data record using the first image data record of the third region, wherein the model data record is representable as a three-dimensional, at least partial model of the first wheel.

15. The method as claimed in claim 10, further comprising:
detecting and producing a second image data record using a further detection device for the first region and/or for the second region and/or for the third region and calculating the first model data record using the second image data records.
